(19) United States
(12) Patent Application Publication
(10) Pub. No.: US 2015/0264297 A1
(43) Pub. Date: Sep. 17, 2015

(54) INFORMATION PROCESSING APPARATUS, INFORMATION PROCESSING SYSTEM, AND STORAGE MEDIUM

(71) Applicants: Taeko ISHIZU, Kanagawa (JP); Junichi HARA, Kanagawa (JP); Kei OYAMADA, Kanagawa (JP)

(72) Inventors: Taeko ISHIZU, Kanagawa (JP); Junichi HARA, Kanagawa (JP); Kei OYAMADA, Kanagawa (JP)

(21) Appl. No.: 14/627,565

(22) Filed: Feb. 20, 2015

(30) Foreign Application Priority Data
Mar. 11, 2014 (JP) 2014-047770

(51) Int. Cl. H04N 5/95; H04N 5/935

(52) U.S. Cl. CPC H04N 5/95; H04N 5/935

(57) ABSTRACT

An information processing apparatus includes an acquisition unit to acquire movie data, including video data and audio data, stored in a given storage area, a separator to separate the video data and the audio data of the movie data acquired by the acquisition unit, a determination unit to determine whether the movie data acquired by the acquisition unit is replayable by conducting at least one of a first process and a second process. In the first process, the determination unit determines whether the movie data is replayable by comparing time information attached to the video data and time information attached to the audio data separated by the separator. In the second process, the determination unit determines whether the movie data is replayable by checking whether the separator correctly separates the video data and the audio data from the start to the end of movie data.

### CROSS-REFERENCE TO RELATED APPLICATION

This application claims priority pursuant to 35 U.S.C. §119(a) to Japanese Patent Application No. 2014-047770, filed on Mar. 11, 2014 in the Japan Patent Office, the disclosure of which are incorporated by reference herein in their entirety.

### BACKGROUND

The present invention relates to an information processing apparatus, an information processing system, and a storage medium.

### BACKGROUND ART

Movie data can be replayed using various apparatuses. For example, computers such as personal computers (PC) can be used to replay movies on a display, and image projection apparatuses such as projectors can be used to project movies. Some projectors have information processing capability that decodes movie files, with which movie files stored in a universal serial bus (USB) memory can be decoded and projected.

However, since various format standards are used for movie data, the movie data using certain format standards cannot be processed by some image projection apparatuses, and in this case, it is required to actually replay movie data to determine whether the movie data is replayable from the start to the end of the movie data, which is a time-consuming process.

### SUMMARY

In one aspect of the present invention, an information processing apparatus is devised. The information processing apparatus includes an acquisition unit to acquire movie data, including video data and audio data, stored in a given storage area, a separator to separate the video data and the audio data of the movie data acquired by the acquisition unit, a determination unit to determine whether the movie data acquired by the acquisition unit is replayable by conducting at least one of a first process and a second process. In the first process, the determination unit determines whether the movie data is replayable by comparing time information attached to the video data and time information attached to the audio data separated by the separator. In the second process, the determination unit determines whether the movie data is replayable by checking whether the separator correctly separates the video data and the audio data from the start to the end of movie data.

In another aspect of the present invention, an information processing system is devised. The information processing system includes a storage apparatus to store movie data including video data and audio data, an acquisition unit to acquire the movie data from the storage apparatus, a separator to separate the video data and the audio data of the movie data acquired by the acquisition unit, and a determination unit to determine whether the movie data acquired by the acquisition unit is replayable by conducting at least one of a first process and a second process. In the first process, the determination unit determines whether the movie data is replayable by comparing time information attached to the video data and time information attached to the audio data separated by the separator. In the second process, the determination unit determines whether the movie data is replayable by checking whether the separator correctly separates the video data and the audio data from the start to the end of movie data.

In another aspect of the present invention, a non-transitory computer-readable storage medium storing a program that, when executed by a computer having a processing circuitry, causes the computer to execute a method of processing an image by using an information processing apparatus is devised. The method includes the steps of acquiring movie data, including video data and audio data, stored in a given storage area, separating the video data and the audio data of the movie data acquired by the acquiring step, determining whether the movie data acquired by the acquisition unit is replayable by conducting at least one of a first process and a second process. In the first process, determining whether the movie data is replayable by comparing time information attached to the video data and time information attached to the audio data separated by the separator. In the second process, determining whether the movie data is replayable by checking whether the separator correctly separates the video data and the audio data from the start to the end of movie data.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is an example of a hardware configuration of an information processing apparatus according to one or more example embodiments of the present invention;

FIG. 2 is an example of a functional configuration of the information processing apparatus of FIG. 1;

FIG. 3 is a flowchart showing the steps of a replayable determination process of movie data conducted by a CPU of the information processing apparatus of FIG. 1;

FIG. 4 is the steps of a movie replay processing at the information processing apparatus of FIG. 1;

FIG. 5 is the steps of a replayable/not-replayable determination process;

FIG. 6 is a flowchart showing the steps of a replayable determination process corresponding to the steps of FIG. 5

FIG. 7 is anther steps of replayable/not-replayable determination process;

FIG. 8 is a schematic data configuration of a movie file;

FIG. 9 is a flowchart showing the steps of a replayable determination process corresponding to the steps of FIG. 7; and

FIG. 10 is an example of a registration style of results of a replayable determination process.

The accompanying drawings are intended to depict exemplary embodiments of the present invention and should not be interpreted to limit the scope thereof The accompanying drawings are not to be considered as drawn to scale unless explicitly noted, and identical or similar reference numerals designate identical or similar components throughout the several views.

### DETAILED DESCRIPTION

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, apparatus or system according to one or more example embodiments are described hereinafter.

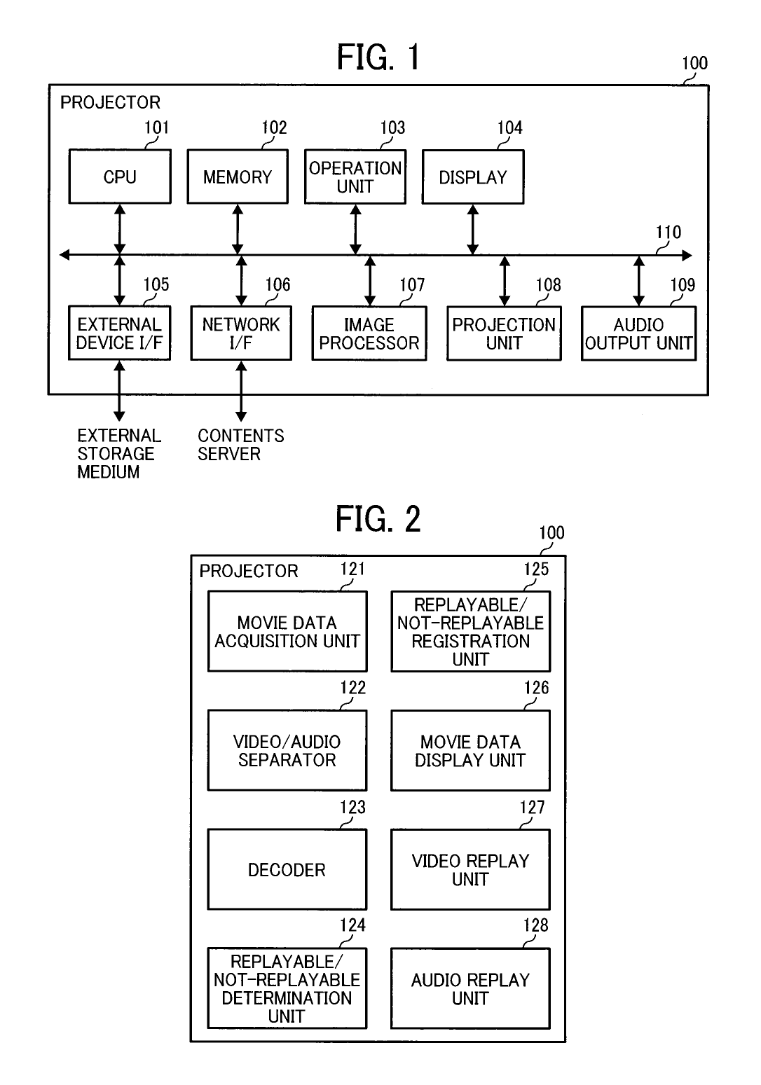

FIG. 1 is a hardware configuration of a projector 100, which is an example of an information processing apparatus, according to one or more example embodiments of the present invention. As illustrated in FIG. 1, the projector 100 includes, for example, a central processing unit (CPU) 101, a memory 102, an operation unit 103, a display 104, an external device interface (I/F) 105, a network interface (I/F) 106, an image processor 107, a projection unit 108, and an audio output unit 109, which are connectable with each other by using a system bus 110.

The CPU 101 executes programs stored in the memory 102 to control the projector 100 as a whole, and implements various functions such as functions to be described with reference to FIG. 2. For example, one function is used to acquire movie data stored in a given storage area and to determine whether the movie data is replayable by the projector 100.

The memory 102 includes, for example, a random access memory (RAM) useable as a working area, and a non-volatile memory such as a flash memory that can rewrite data. The non-volatile memory stores various programs executable by the CPU 101 and various data to be described later. Further, the non-volatile memory can store movie data to be replayed by the projector 100.

The operation unit 103 is an operation unit that receives operations by a user. The operation unit 103 includes, for example, various buttons and switches, and a touch panel. The display 104 is a presentation unit that displays operation status and settings of the projector 100 to a user. The display 104 includes, for example, a liquid crystal display and a lamp. The operation unit 103 and the display 104 can be provided as external devices, and the projector 100 can be connected to an external terminal such as a personal computer (PC) via a network, in which the projector 100 receives operation instructions from the external terminal.

The external device I/F 105 is an interface that connects the projector 100 with a detachable external storage medium, and an external apparatus such as PC that can be used as an video input source. For example, the external device I/F 105 can employ an interface of USB standard.

The network I/F 106 is an interface that connects the projector 100 with an external apparatus such as a contents server via a network such as local area network (LAN) and the Internet to communicate information between the projector 100 and the external apparatuses. The communication standard can employ any standards for wired and wireless communication.

The image processor 107 separates video data and audio data from a to-be-replayed movie data, and decodes and converts the video data to data suitable for projection by the projection unit 108, and decodes and converts the audio data to data suitable for audio output by the audio output unit 109. This process can be conducted by a computing function of the CPU 101, but if a dedicated hardware is used, this process can be conducted with high speed and stably.

The projection unit 108 can be used as a display unit that displays a video image on a screen, a wall face or the like by projecting the video image. Further, the projection unit 108 can be used as a presentation unit that presents operation status and settings of the projector 100 to a user.

The audio output unit 109 can be used an audio output unit that outputs audio. The audio output unit 109 can be a speaker that outputs audio, or can be an output unit that outputs audio signal to an external audio output apparatus such as a speaker.

As to the projector 100, a video input from a video input source connected to the external device I/F 105 can be projected by the projection unit 108. Further, movie data acquired from the memory 102, an external storage medium, or a contents server can be decoded and replayed as video output and audio output. The replayable standard of movie data may be MP4 (ISO/IEC 14496-14:2003), MPEG 2 (generic coding of moving pictures and associated audio information) or the like.

As to the projector 100 of one or more example embodiments, it can determine whether movie data acquired by the projector 100 is correctly replayable by the projector 100 before actually replaying the movie data.

A description is given of functional configuration of the projector 100 with reference to FIG. 2. As illustrated in FIG. 2, the projector 100 is configured with, for example, a movie data acquisition unit 121, a video/audio separator 122, a decoder 123, a replayable/not-replayable determination unit 124, a replayable/not-replayable registration unit 125, a movie data display unit 126, a video replay unit 127, and an audio replay unit 128. These functions can be implemented by controlling various hardware illustrated in FIG. 1 by the CPU 101.

The movie data acquisition unit 121 can be used as an acquisition unit that acquires movie data (movie file if file format is used) stored in a given storage area based on a user's instruction or designation, and settings set to the projector 100. The storage area can be defined by path information indicating a position in the memory 102, a position in an external storage medium connected via the external device I/F 105, or address and uniform resource locator (URL) indicating a position on a network. These information can be information indicating a file, information indicating a folder including a plurality of files, and information including a file search condition. Further, the acquisition process of movie data file when replaying a movie and the acquisition process of movie data file when determining replayable or not are the same acquisition process.

The video/audio separator 122 can be used as a separator that separates video data and audio data included in the movie data in view of the format of movie data acquired by the movie data acquisition unit 121, and acquires the video data and audio data.

The decoder 123 decodes the video data and audio data separated by the video/audio separator 122 to data with a format suitable for projection and data with a format suitable for audio output.

The processing by the video/audio separator 122 and the decoder 123 when replaying a movie and the processing by the video/audio separator 122 and the decoder 123 when determining replayable or not are the same processing.

The replayable/not-replayable determination unit 124 can be used as a determination unit that determines whether a process target movie data is replayable by the projector 100 based on a separation result by the video/audio separator 122 and/or a decoding result by the decoder 123. Further, the replayable/not-replayable determination unit 124 can determine a reason when the replay is not conductable, which will be described later.

The replayable/not-replayable registration unit 125 can be used as a registration unit to register a determination result determined by the replayable/not-replayable determination unit 124 by correlating information for identifying determination target movie data and the determination result by the replayable/not-replayable determination unit 124. The information for identifying movie data can be a combination of file name, acquisition position, updating data and time, other properties, which can be combined as required. If properties of movie data are editable, the determination result can be written to the properties, in which the movie data itself includes information for identifying the movie data.

Further, when a storage area of determination target movie data is an external apparatus outside the projector 100, the replayable/not-replayable registration unit 125 can be used as transmitter that transmits a determination result of the replayable/not-replayable determination unit 124 to the external apparatus. If the external apparatus that has received the determination result has required functions, the external apparatus correlates the determination result to the concerned movie data, which is a determination target, and registers the determination result and movie data collectively. After this registration, when the projector 100 accesses the external apparatus, the external apparatus can provide the determination result information to the projector 100.

The movie data display unit 126 can display a list of movie data stored in a given storage area based on an instruction by a user and settings set to the projector 100, and the display of the list of movie data can be conducted by projecting an image by the projection unit 108 on the display 104, or by displaying on a screen of an external terminal apparatus such as PC.

Further, the list of movie data can be displayed using file names and icons indicating movie data stored in a given storage area. In this case, if a determination result of replayable or not for a to-be-displayed movie data can be referred, the determination result is displayed by correlating the file name or icon with the determination result. A display style of the file name or icon (e.g., color, size, image, font, decoration) can be matched to the determination result. If the determination result is a result indicating not-replayable, the display style can be set differently depending on the reason, or the determination result can be displayed using characters or text.

The video replay unit 127 can be used to project (i.e., output) an image by using the projection unit 108 based on the video data decoded by the decoder 123. The audio replay unit 128 can be used to output audio by using the audio output unit 109 based on the audio data decoded by the decoder 123.

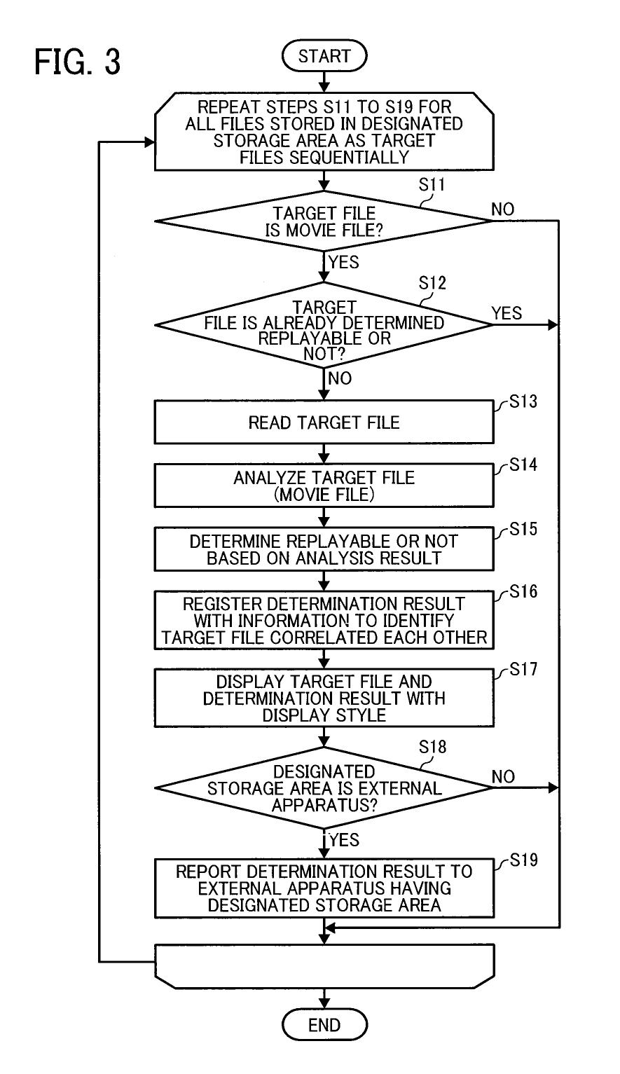

A description is given of replayable determination process of movie data conducted by the CPU 101 with reference to FIG. 3, which is a flowchart showing the steps of a process for determining whether the movie data is replayable. When the CPU 101 confirms that it can access a storage area designated as a determination target, the CPU 101 starts a process of FIG. 3 at a given timing to determine whether movie data stored in the storage area is replayable.

The storage area can be designated as above described for the description of the movie data acquisition unit 121. Further, when the storage area is an external storage medium, the given timing may mean, for example, when the external storage medium detects that the external storage medium is connected to the projector 100, when the external storage medium is instructed to display a list of file stored in a storage area, or when detecting that the processing load by CPU 101 becomes low other than power save mode. Since the replayable determination process requires a given length of time, the replayable determination process is preferably conducted at a timing before using the determination result

In the process of FIG. 3, the CPU 101 repeats the process from steps S11 to S19 for all files (i.e., process target files) stored in a designated storage area sequentially. At first, the CPU 101 determines whether a target file is a movie file or data (S11), in which the CPU 101 may not check contents of the file data but may refer to a file name extension and properties of the file data.

If the target file is a movie file (S1: Yes), the CPU 101 determines whether the target file is already determined as replayable or not (S12). This determination can be conducted based on whether the replayable/not-replayable registration unit 125 registers a determination result corresponding to the target file.

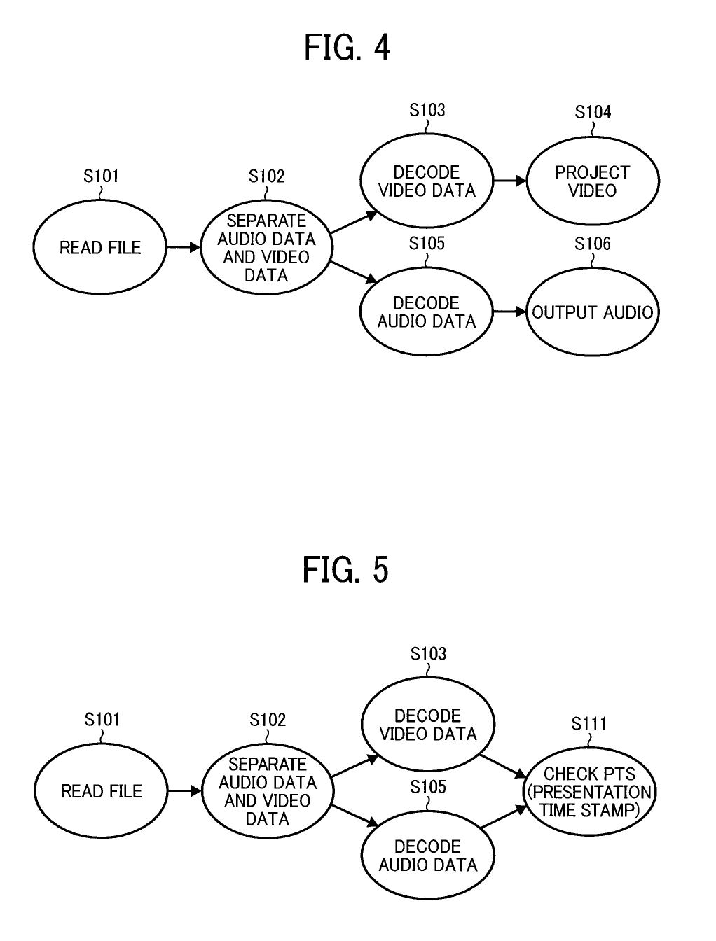

If the determination is not yet conducted (S12: No), the CPU 101 reads the target file (S13), and analyzes the read file such as movie file (S14). Then, based on an analysis result, the CPU 101 determines whether the target file is replayable or not (S15). The detail of the analysis and determination will be described later with reference to FIGS. 4 to 9.

Then, the CPU 101 correlates the determination result and information for identifying the target file, and registers the determination result and the information for identifying the target file (S16). Further, the CPU 101 sets a display style used for displaying the target file with the corresponding determination result (S17). Further, if the designated storage area is an external apparatus or device (S18: Yes), the CPU 101 reports the determination result at step S15 to the external apparatus or device including the designated storage area (S19).

The above described processing can be conducted for each file, and if the above described processing is completed for all files, the process of FIG. 3 ends. Further, if the result of step S11 is No, step S12 is Yes, or step S18 is No, the processing for the target file ends at these steps. In the above described processing, the process at step S13 corresponds to the function of the movie data acquisition unit 121, the process at step S15 corresponds to the function of the replayable/not-replayable determination unit 124, and the process from steps S16 to S19 corresponds to the replayable/not-replayable registration unit 125.

A description is given of analysis and replayable determination process of movie file at steps S14 and S15 in FIG. 3 with one example, in which a part of movie replay function of the projector 100 is used. A description is given of movie replay processing at the projector 100 with reference to FIG. 4, which is the steps of a movie replay processing at the projector 100, which can be conducted by the CPU 101 and the image processor 107.

When the projector 100 is to replay a movie, a to-be-replayed movie file is read (S101). Then, audio data and video data are separated from the movie file (S102). Then, the video data is decoded to acquire image data for each frame (S103), and then the image data is output (i.e., projected) by the projection unit 108 (S104). Further, along with S103 and S104, the audio data is decoded to acquire waveform data of each sampling frequency (S105), and then audio is output by the audio output unit 109 (S106).

In this processing, each of the video data and audio data is attached with time information such as replay time information, which is used to synchronize the video data and audio data. The time information can be called, for example, presentation time stamp (PTS) for MPEG 2 format.

A description is given of a case using PTS. When a movie file is to be replayed, video data and audio data are decoded and output separately, but the decoded results of the video data and audio data are stored in a buffer for a given time period, time of the decoded video data and time of decoded audio data are matched using PTS, and then the video and audio are output using the video data and the audio data at the same replay time, with which the video and audio can be replayed with synchronized manner.

However, PTS of the video data and PTS of the audio data stored in the buffer may deviate greatly in some cases such as when data loss or damage occurs and decoded data loses samples after decoding, when the decoding needs longer time, and when a position of video data and a position of audio data in movie data is too far with each other. If the deviation is small, matching of the time of the video data and audio data can be conducted by changing reading positions in the buffer. However, if the deviation is great such as data of the same time do not exist in the buffer, matching of the time of the video data and audio data cannot be conducted. In this case, data deviation or skipping occurs between the video data and the audio data, and thereby the movie data cannot be replayed correctly.

In view of this situation, as one example of replayable determination process, the decoding is conducted actually, PTS of video data and PTS of audio data stored in the buffer at each time are compared, and then the replayable determination process is conducted based on a comparison result of PTS. For example, PTS of data at the front position in the buffer can be compared.

FIG. 5 is the steps of the replayable/not-replayable determination process using the comparison of PTS method. The steps of FIG. 5 is same as the steps of FIG. 4 until decoding video data and audio data. Then, instead of the projection output and the audio output, PTS of decoded data stored in the buffer are checked (S111). Further, data stored in the buffer can be updated to new data along the time line same as the replaying process of data,

If the deviation of PTS of video data and PTS of audio data is within a given range from the start to the end of movie data, it is determined that the target movie data is correctly replayable based on a comparison result of PTS.

Further, if the deviation of PTS of video data and PTS of audio data is not within the given range at one point of movie data, audio displacement occurs to the target movie data, and it is determined that the target movie data is not correctly replayable. The level of audio displacement can be evaluated based on the level of exceeding the given range, the number of times exceeding the given range, time when exceeding the given range or the like.

Further, if the decoding cannot be completed correctly from the start to the end of the data, it is determined that the target movie data is not correctly replayable due to data damage. For example, if a plurality of movies are connected and the format of movie files changes in the middle of movie files, or if data loss is great, the decoding cannot be conducted in the middle of movie files. Even in this case, the file format itself may be normal, and thereby abnormality can be detected after analyzing the contents of movie file.

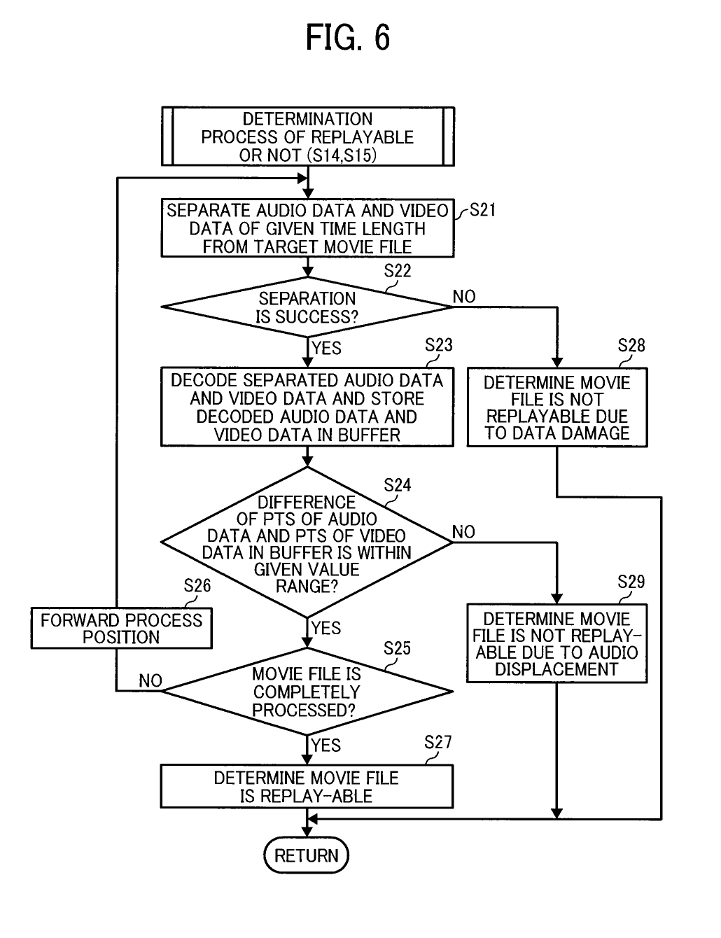

FIG. 6 is a flowchart showing the steps in step S14 and S15 of FIG. 3 conducted by the CPU 101 when the replayable determination process is conducted by this PTS method. In this case, at first, the CPU 101 separates audio data and video data for a given time length from a movie file, which is a process target (S21). Then, the CPU 101 determines whether the separation is successfully conducted (S22). When the separation is successfully conducted (S22: Yes), the CPU 101 decodes the separated audio data and video data, and stores the decoded audio data and video data in the buffer (S23).

Then, the CPU 101 compares PTS of the audio data and PTS of the video data stored in the buffer to determine whether a difference of PTS is within a given value range (S24). If the difference of PTS is within the given value range (S24: Yes), the CPU 101 determines whether the processing is conducted from the start to the end of the movie file (S25). If the difference of PTS is not within the given value range (S25: No), the CPU 101 forwards a process position and returns the process to step S21, and repeats the process.

If the result of step S25 is Yes, it means that the abnormality is not detected for the entire of the movie file (i.e. from the start to the end of the movie file), with which the CPU 101 determines that the process target movie file is replayable (S27), and proceeds the process to S16 and subsequent steps in FIG. 3.

Further, if the result of step S22 is No, the CPU 101 determines that the process target movie file is not replayable due to data damage (S28), and proceeds the process to S16 and subsequent steps in FIG. 3. Further, if the result of step S24 is No, the CPU 101 determines that the process target movie file is not replayable due to audio displacement (S29), and proceeds the process to S16 and subsequent steps in FIG. 3. Further, if the level of displacement is to be detected, after step S29, the CPU 101 can continue the process from steps S21 to S24 till the end of the file.

As to the above described processing, it can determine whether the process target movie file is correctly replayable by the projector 100 without actually replaying a movie. Since the separation and decoding of audio data and video data are conducted with the same process for replaying movie data, abnormality that may occur due to contents of movie data when replaying the movie data can be detected for any types of movie data or files.

The decoding speed and synchronization processing capability for movie data depend on capability of hardware and software used for processing movie data. Therefore, a movie file that can be correctly replayed in one environment may not be correctly replayed in another environment.

Abnormality caused by the processing capability of movie data by the projector 100 can be detected when the projector 100 actually conducts the decoding using a hardware and software employed for movie replay, and then determines whether the movie data is replayable or not. Especially, if a processing resource that is used for movie data replay in an apparatus is small, abnormality may occur to a movie file, which can be correctly replayed by other apparatuses. Therefore, by actually conducting the decoding and replayable determination process, abnormality caused by the processing capability of movie data by the projector 100 can be effectively detected. Further, since known movie data replay capability can be used for most of the replayable determination process, the development cost of replayable determination process can be suppressed.

The above described determination method includes the decoding process same as when replaying a movie, and thereby time required for determination becomes one half to three fourth (½ to ¾) of time required replaying the movie actually, or if determination is conducted with the completely same conditions of replaying the movie, the time required for determination becomes the same time required for replaying the movie actually. If the determination process is conducted when the projector 100 is not busy, the above mentioned time issue can be solved. Further, if time required for determination is to be shortened, the decoding process and replayable determination process can be conducted by thinning out data.

A description is given of another method of the replayable determination process. In this another method, when separating video data and audio data, PTS of video data and PTS of audio data are extracted from information attached to movie data. Then, the PTS of video data and the PTS of audio data are compared, and the replayable determination process is conducted based on a comparison result of PTS.

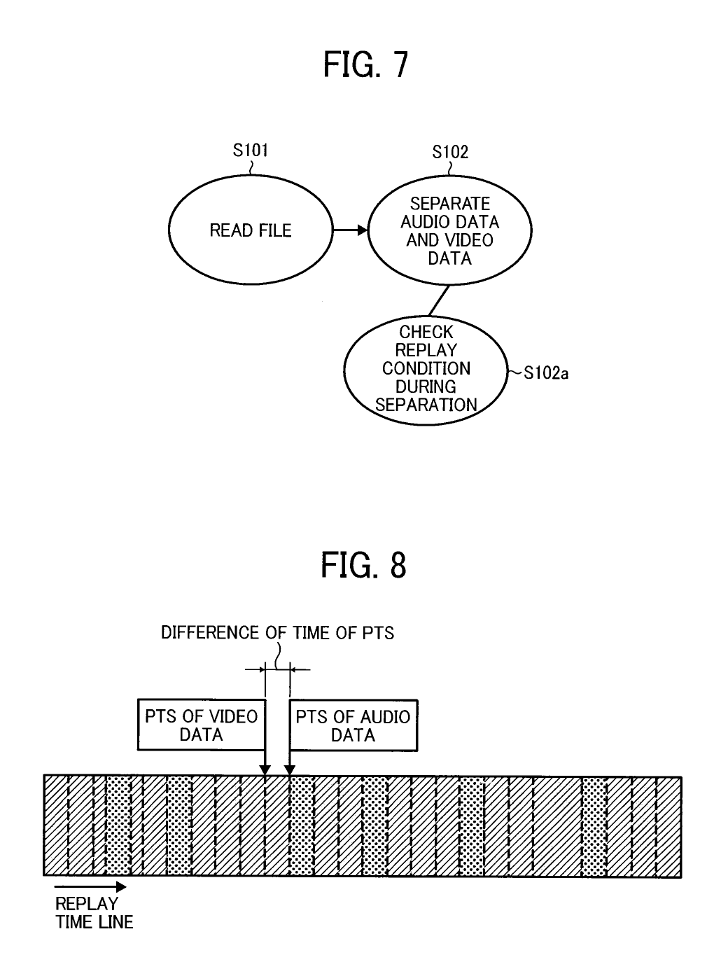

FIG. 7 is the steps of replayable/not-replayable determination process by this another method. As to the steps of FIG. 7, reading of a movie file (S101) is same as the step of FIG. 4. In the process of separating audio data and video data from a movie file (S102), replay condition is checked (S102a).

FIG. 8 is a schematic data configuration of a movie file. As illustrated in FIG. 8, in a movie file, video data (see inclined line hatching) and audio data (see dot hatching) are arranged along the replay time sequence based on a standard of movie data. Further, the video data and the audio data are segmented into blocks as indicated by dot lines, and each block is attached with PTS indicating the replay start time of data for the block.

When replaying the movie file, video data and audio data are separated and extracted sequentially from the front data of the file, and decoded. Therefore, data of adjacent blocks are decoded at time close to each other, and stored in the buffer. Therefore, if the difference of PTS of audio data and PTS of video data, which are adjacent data, is small in the movie data, data existing almost at the same time are stored in the buffer, and thereby the movie can be correctly replayed.

However, if the difference of PTS of data in the buffer is great, and the decoded data are stored in the buffer, replay time of audio data and replay time of video data may deviate greatly, with which audio displacement may occur, and thereby the movie cannot be correctly replayed.

As to this replayable determination process method, replayable or not of movie data can be determined based on whether the difference of time between PTS of audio data and PTS of video data, which are adjacent data in a movie file, is within a given value range. The given value used for this another method can be set in view of movie replay capability of the projector 100, wherein the movie replay capability means what level of difference of PTS can be adjusted by the movie replay capability. As same as the method of FIG. 5, the level of audio displacement can be evaluated based on the level of exceeding the given value range, the number of times exceeding the given value range, time when exceeding the given value range or the like, and it can determine that replay is impossible when the data separation cannot be conducted.

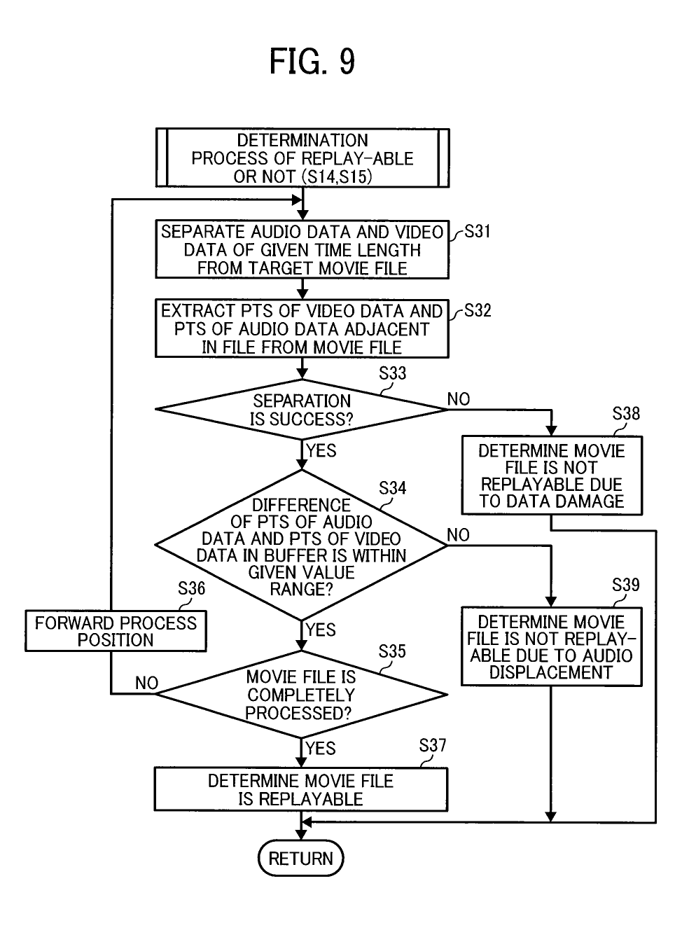

FIG. 9 is a flowchart showing the steps of process at steps S14 and S15 in FIG. 3 conducted by the CPU 101 when the replayable determination process is conducted using this another method. In this case, at first, the CPU 101 separates audio data and video data of a given time length from a process target movie file (S31). Then, the CPU 101 extracts PTS of audio data and PTS of video data adjacent in the movie file (S32). If a combination of audio data and video data exists for a plurality of numbers, the CPU 101 extracts a plurality of combinations of PTS of audio data and PTS of video data adjacently existing in the movie file. The separation process at step S31 is not required to extract audio data and video data separately, but the separation at step S31 can be conducted just to identify position of audio data and position of video data in the file in view of the extraction of PTS at step S32.

Then, the CPU 101 determines whether the separation at step S31 is success (S33). If the separation is success (S33: Yes), the CPU 101 determines whether a difference of PTS of the audio data and PTS of the video data, extracted at step S32, is within a given value range (S34).

If the difference for one combination of audio data and video data (or a plurality of combinations of audio data and video data) is within the given value range (S34: Yes), the CPU 101 determines whether the movie file is processed from the start to the end of the file (S35).

If the result of step S35 is No, the CPU 101 forwards the process position (S36) and returns the process to step S31, and repeats the process. If the result of step S35 is Yes, it means that abnormality is not detected till the end of the file (from the start to the end of the file), and the CPU 101 determines that the process target movie file is replayable (S37), and the CPU 101 proceeds the process to S16 and subsequent steps in FIG. 3.

Further, if the result of step S33 is No, the CPU 101 determines that the process target movie file is not replayable due to data damage (S38), and proceeds the process to S16 and subsequent steps in FIG. 3. Further, if the result of step S34 is No, the CPU 101 determines that the process target movie file is not replayable due to audio displacement (S39), and proceeds the process to S16 and subsequent steps in FIG. 3. Further, if the level of displacement is to be detected, after step S39, the CPU 101 can continue the process from steps S31 to S34 until the end of the file.

As to the above described processing of another method, it can determine whether the process target movie file is correctly replayable at the projector 100 without actually replaying a movie. Since the decoding of audio data and video data is not conducted, detection precision of replay-malfunction due to factors specific to the projector 100 may not be high compared to the method of FIG. 5, but the processing speed can be set faster.

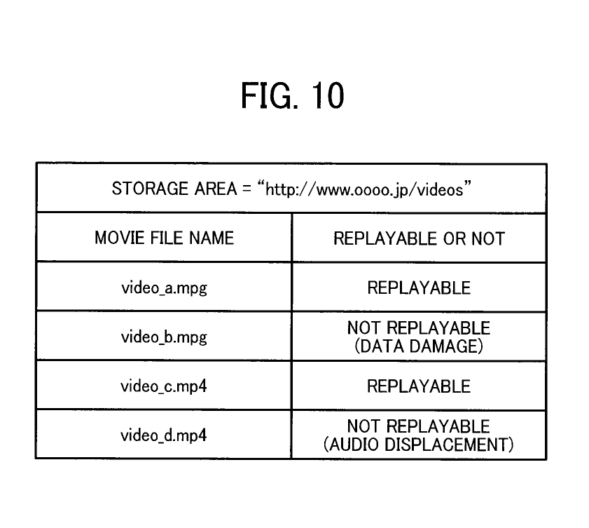

FIG. 10 is an example of a registration style of determination result at step S16 of FIG. 3. In an example of FIG. 10, information for identifying movie data is configured with, for example, URL identifying a folder used as a storage area, and a movie file name of each movie data in the folder. Further, a determination result of replayable or not is registered for each movie file. If a movie file is not replayable, a reason such as “data damage” or “audio displacement” is registered.

The determination result is registered preferably in each storage area of each movie data. Thereafter, when a user operates the projector 100 and requests to display a movie file stored in the storage area, the determination result in the storage area can be read. Then, attribution information of the movie file acquired from the storage area is compared with information for identifying movie data included in the determination result to acquire information of replayable or not for each movie file. Then, by using this information, a name or an icon of the requested movie file stored in the storage area can be displayed with a display style having status of replayable or not of each movie file, and a reason of not replayable.

As to movie files that a determination result is not acquired, the process of FIG. 3 is conducted during the display to acquire a determination result of replayable or not, and then a determination result is acquired for the movie files. Starting from a movie file that acquires a determination result, the movie file can be displayed with a display style corresponding to the determination result.

By conducting the above described processing and displaying, a user can recognize whether a to-be-replayed movie data is replayable at the projector 100 easily, and can prevent replaying of files which causes problems during the replay.

Further, if the user can recognize the reason of not replayable, the user can use the projector flexible manner. For example, when audio displacement of a file is not so great. the user can choose to replay the file.

Further, by transmitting and storing a determination result to an apparatus that stores movie data, when displaying a list of movie files or icons of movie files, the determination result can be acquired with attribution information of movie files, and the above described display can be conducted. By registering the determination result to properties of movie files, the above described display can be also conducted. By conducting the above described processing, the determination result of each of movie data can be managed easily.

As to the above described example embodiments, it should be noted that configurations of each apparatus, processes, methods and standards of replayable determination process method and data format are not limited to the above described example embodiments. For example, as to the replayable determination process, it is not required to confirm whether both of PTS comparison and separation are completed correctly. Further, a threshold used for PTS comparison can be set by a user. Further, time information other than PTS can be used such as information matched to movie data standard. Further, if movie data includes video, audio, and other data, the other data can be also used as an analysis target of replayable determination process.

As to the above described configuration of the one or more example embodiments, it can determine whether movie data is replayable at an information processing apparatus without actually replaying the movie data.

Further, the above described information processing apparatus can be also applied to apparatuses other than projectors. For example, the above described information processing apparatus can be applied to a movie replay apparatus that displays replay-target movie on a screen, and a replay apparatus that outputs video and audio signals obtained by replaying movie data to an external display apparatus and an external audio apparatus. The above described information processing apparatus can be implemented in any convenient form, for example using dedicated hardware such as computer, or a mixture of dedicated hardware and software to replay movie data.

Further, the above described projector 100 and one or more contents servers accessible from the projector 100 can be configured as an information processing system such as a movie replay system, in which the contents server can be used as a storage apparatus that stores movie data. As to this information processing system, functions of the projector 100 and contents server can be disposed in a plurality of apparatuses, and these apparatuses can collectively conduct the above described functions. Further, the storage apparatus is not required to have a server function, but can be used as a storage alone if the information processing apparatus can access the storage apparatus and acquire movie data.

Further, the above described processing can be implemented in any convenient form, for example using dedicated hardware, or a mixture of dedicated hardware and software program, in which the computer controls the hardware to implement functions of the information processing apparatus such as the projector 100.

The present invention can be implemented in any convenient form, for example using dedicated hardware platform, or a mixture of dedicated hardware platform and software. Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions. The illustrated server apparatuses are only illustrative of one of several computing environments for implementing the embodiments disclosed herein. For example, in some embodiments, any one of the information processing apparatus may include a plurality of computing devices, e.g., a server cluster, that are configured to communicate with each other over any type of communication links, including a network, a shared memory, etc. to collectively perform the processes disclosed herein.

The computer software can be provided to the programmable device using any storage medium or carrier medium such as non-volatile memory for storing processor-readable code such as a floppy disk, a compact disk read only memory (CD-ROM), a compact disk rewritable (CD-RW), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a flash memory, Blu-ray disc (registered trademark), SD card, a solid state memory device or the like, but not limited these. Further, the computer software can be provided through communication lines such as electrical communication line. Further, the computer software can be provided in a read only memory (ROM) disposed for the computer. The computer software stored in the storage medium can be installed to the computer and executed to implement the above described processing. The computer software stored in the storage medium or apparatus of an external apparatus can be downloaded and installed to the computer via a network to implement the above described processing.

The hardware platform includes any desired kind of hardware resources including, for example, a central processing unit (CPU), a random access memory (RAM), and a hard disk drive (HDD). The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C++, Java (registered trademark), JavaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps. In the above-described embodiments, at least one or more of the units of apparatus can be implemented as hardware or as a combination of hardware/software combination. Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

Numerous additional modifications and variations for the communication terminal, information processing system, and information processing method, a program to execute the information processing method by a computer, and a storage or carrier medium of the program are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An information processing apparatus comprising:
an acquisition unit to acquire movie data, including video data and audio data, stored in a given storage area;
a separator to separate the video data and the audio data of the movie data acquired by the acquisition unit;
a determination unit to determine whether the movie data acquired by the acquisition unit is replayable by conducting at least one of a first process and a second process,
in the first process, the determination unit determines whether the movie data is replayable by comparing time information attached to the video data and time information attached to the audio data separated by the separator, and
in the second process, the determination unit determines whether the movie data is replayable by checking whether the separator correctly separates the video data and the audio data from the start to the end of movie data.

2. The information processing apparatus of claim 1, further comprising
a registration unit to register a determination result of the movie data determined by the determination unit by correlating the determination result and information identifying the movie data; and
a display control unit to display a determination result of the movie data registered in the registration unit for the movie data stored in the given storage area.

3. The information processing apparatus of claim 2,
wherein when the determination result is not-replayable of the movie data, the registration unit registers the determination result and a reason of not-replayable of the movie data, and
the display control unit displays a display style used for displaying the determination result with a reason of not-replayable registered in the registration unit for the movie data stored in the given storage area.

4. The information processing apparatus of claim 1, further comprising a transmitter to transmit a determination result determined by the determination unit to an external apparatus when the given storage area is the external apparatus.

5. An information processing system comprising:
a storage apparatus to store movie data including video data and audio data;
an acquisition unit to acquire the movie data from the storage apparatus;
a separator to separate the video data and the audio data of the movie data acquired by the acquisition unit; and
a determination unit to determine whether the movie data acquired by the acquisition unit is replayable by conducting at least one of a first process and a second process,
in the first process, the determination unit determines whether the movie data is replayable by comparing time information attached to the video data and time information attached to the audio data separated by the separator, and
in the second process, the determination unit determines whether the movie data is replayable by checking whether the separator correctly separates the video data and the audio data from the start to the end of movie data.

6. The information processing system of claim 5, further comprising:
a registration unit to register a determination result of the movie data determined by the determination unit by correlating the determination result and information identifying the movie data; and
a display control unit to display a determination result of the movie data registered in the registration unit for the movie data stored in the given storage area.

7. The information processing system of claim 6,
wherein when the determination result is not replayable of the movie data, the registration unit registers the determination result and a reason of not-replayable of the movie data, and
the display control unit displays a display style used for displaying the determination result with a reason of not-replayable registered in the registration unit for the movie data stored in the given storage area.

8. A non-transitory computer-readable storage medium storing a program that, when executed by a computer having a processing circuitry, causes the computer to execute a method of processing an image by using an information processing apparatus, the method comprising the steps of:
acquiring movie data, including video data and audio data, stored in a given storage area;
separating the video data and the audio data of the movie data acquired by the acquiring step;
determining whether the movie data acquired by the acquisition unit is replayable by conducting at least one of a first process and a second process,
in the first process, determining whether the movie data is replayable by comparing time information attached to the video data and time information attached to the audio data separated by the separator, and
in the second process, determining whether the movie data is replayable by checking whether the separator correctly separates the video data and the audio data from the start to the end of movie data.
